(19) United States
(12) Patent Application Publication
(10) Pub. No.: US 2026/0021791 A1
(43) Pub. Date: Jan. 22, 2026

(54) FAIRED WINDSCREEN WIPER BLADE

(71) Applicant: VALEO SYSTEMES D'ESSUYAGE, La Verriere (FR)

(72) Inventors: Nathalie LALOI, La Verriere (FR); Guillaume BARRET, La Verriere (FR)

(73) Assignee: VALEO SYSTEMES D'ESSUYAGE, La Verriere (FR)

(21) Appl. No.: 18/993,632

(22) PCT Filed: Jun. 26, 2023
(86) PCT No.: PCT/EP2023/067294

§ 371 Date: Jan. 13, 2025

(30) Foreign Application Priority Data
Jul. 13, 2022 (FR) FR2207208

(51) Int. Cl. B60S 1/38

(52) U.S. Cl. CPC B60S 1/3806; B60S 2001/3812

(57) ABSTRACT

The invention relates to a windscreen wiper blade for a motor vehicle. The wiper blade includes a fairing, with a central mounting, at least one end cap, and at least one adapter element attached to the central mounting. The adapter element includes a central core and two legs extending from opposite edges of the central core, one of the at least one end cap(s) being pivotally hinged to the adapter element. The adapter element having a narrowed portion in at least one of the two legs, located at the hinge between the end cap and the adapter element and extending from at least one hinge hole to the central core of the adapter element.

### TECHNICAL FIELD

The invention relates to a cowled wiper for motor vehicles, and to a wiper system comprising such a wiper.

### BACKGROUND OF THE INVENTION

In wipers for vehicles, it has become increasingly desirable to incorporate an aerodynamic appearance in the wiper, insofar as the aerodynamic elements constitute a major part of the structure of the wiper. Such wipers are commonly referred to as “hybrid” wipers.

Such an aerodynamic appearance has a certain number of advantages, notably that of reducing the drag force of the flow of air incident on the wiper. The aerodynamic shape can also be configured to generate a normal force on the wiper when the air passes across it, pressing the wiper against the windshield and improving the wiping performance. The profiled shape also has a more pleasant esthetic appearance than a wiper configured in the more traditional style of yokes at multiple levels.

In “hybrid” wipers, the aerodynamic appearance is implemented in the form of a rigid cowling which constitutes part of the structure of the wiper. The cowling generally comprises multiple individual components, which are articulated to one another so as to allow the wiper to bend and follow the curvature of the windshield when the wiper passes over it. Furthermore, and depending on the length of the wiper, the wiper may comprise a single level of yokes (also referred to as “brackets”) which are articulated to the cowling and retain the rubber squeegee, in order to more uniformly distribute the force of the wiper arm over the length of the wiper.

In this way, the cowling constitutes a major part of the structure of the wiper, thereby simplifying its construction.

Given that the central mount and the end caps are rigid elements, and that the wiper must be able to bend to follow the curvature of the windshield, it is necessary to provide a type of articulation means which allows the end caps to pivot with respect to the central mount. In particular, given that the wiper must follow the curvature of the windshield while still maintaining a high degree of wiping performance along its entire trajectory, the articulation of the end caps on the central mount should allow free rotation about a transverse axis, but be rigid and robust in all the other directions and about all the other axes.

One way to do this is to provide an adapter element, which is fastened to one of the central mount or end cap and provides a point to which the other of the central mount or end cap is articulated. This solution is advantageous in the sense that it is economical and easy to implement, notably with respect to an articulation which is formed in one piece with the central mount and the end cap.

However, such a configuration can have drawbacks, insofar as the end cap has to be deformed in order to be able to mount it in articulation on the adapter element. More specifically, during the assembly of the wiper, the sides of the end cap have to be moved apart from one another in order to be able to correctly position the articulation elements of the end cap with respect to the adapter element; the sides are then released and the elasticity of the end cap holds the articulation in place.

This deformation, although a priori of elastic nature, can cause the breakage of the end cap. The end cap generally takes a form with an inverted U or V cross section; any moving apart of the free ends of the cap will therefore concentrate mechanical stresses at the join between the two flanks of the cap. This concentration could cause a breakage of the cap.

More generally, the articulated mounting of such an end cap on the adapter element requires the application of a substantial force on the end cap, either by machine or by a worker.

It is therefore advantageous to provide a wiper cowling which addresses at least one of these disadvantages.

### SUMMARY OF THE INVENTION

Consequently, according to a first aspect, the invention presents a wiper, in particular for a motor vehicle, comprising a cowling comprising a central mount and at least one end cap disposed in the continuation of said central mount, and at least one adapter element fastened to said central mount, the adapter element comprising a central core and two legs extending from opposite edges of said central core, one of said at least one end caps being pivotably articulated to said adapter element.

According to the invention, the adapter element has a punctiform narrowing of at least one of the two legs at said articulation of said end cap on said adapter element, said narrowing extending from an articulation bore to the central core of said adapter element.

Such a wiper is advantageous in that the presence of the at least one narrowing enables extremely easy articulated mounting of the end cap. In particular, the narrowing makes it possible to mount the articulation of the end cap in the corresponding articulation bore on the adapter in a way which reduces the force that must be exerted on and/or the deformation that must be applied to the end cap during the mounting operation necessary for mounting it on the adapter.

The wiper may further comprise one or more of the following optional aspects, which can be combined freely depending on the needs of the implementation in question.

Advantageously, the narrowing may comprise at least one substantially planar mounting surface, said mounting surface being inclined toward a median plane of the adapter element.

Such a configuration is particularly advantageous in that, by providing this inclined planar surface, the end cap can be mounted on the adapter gradually and easily. The assembly force and the mechanical stresses to which the end cap is subjected during the mounting are similarly reduced.

Advantageously, the narrowing comprises two mounting surfaces disposed oppositely with respect to the median plane of the adapter element.

Such a configuration is advantageous in that this affords a better balance of mounting forces through the median plane. Consequently, the mounting of the cap on the adapter element is facilitated.

Preferably, the at least one end cap comprises two articulation studs extending top-to-tail from a lower surface of said at least one end cap so as to constitute an articulation axis, said articulation studs being push-fitted respectively in two bores formed in the adapter element.

Such a configuration is particularly advantageous in that it affords an articulation between the end cap and the central mount that is both easy to construct and easy to mount.

Optionally, the at least one narrowing is delimited by at least one guide surface formed in the adapter element, said at least one guide surface preferably being substantially planar.

Preferably, the at least one narrowing is delimited by two guide surfaces formed in the adapter element, the at least one mounting surface and the at least two guide surfaces together forming a channel, said at least two guide surfaces preferably being substantially planar.

Preferably, the channel extends from the bores to the central core of the adapter element.

Such a configuration is particularly advantageous in that the provision of the at least one guide surface will facilitate the articulated mounting of the end cap on the adapter element, by permitting a slight misalignment between the component parts. During an articulation operation, the guide surface or surfaces will lead the articulation studs toward the bores by means of the sliding contact between them.

In a possible configuration, the at least one narrowing is inclined at an angle of between 5 and 20 degrees, preferably between 10 and 15 degrees, and more preferably of 13 degrees, with respect to the longitudinal median plane of the adapter element.

The orientation of the at least one narrowing thus affords an optimum balance between compactness and ease of mounting.

According to a second aspect, the invention comprises a wiper system according to the description above.

### BRIEF DESCRIPTION OF DRAWINGS

These aspects, features and advantages of the invention, along with others, will be easily appreciated in the light of the appended figures, in which:

FIG. 1 is a perspective view of a wiper according to one embodiment of the invention;

FIG. 2 is a detail view of the wiper according to FIG. 1;

FIG. 3A is a detail view of the wiper according to FIG. 1;

FIG. 3B is a cross-sectional view of the wiper according to FIG. 1; and

FIG. 4 is a graph illustrating the assembly force for a wiper according to FIG. 1.

### DETAILED DESCRIPTION OF THE INVENTION

The invention will be better understood in the context of the figures and in the light of the discussion below.

To make it easier to understand the figures in relation to the description that follows, it should firstly be noted that, in some of the figures, one or more axes are illustrated. More specifically, it will be noted that these axes follow the overall direction of the wiper: they will therefore be understood as being a longitudinal axis which follows the length of the wiper; a transverse axis perpendicular to said longitudinal axis in a direction parallel to the surface of a windshield on which the wiper is placed; and a vertical axis perpendicular to said longitudinal axis and to said windshield surface.

Furthermore, when relative terms such as “upper” and “lower” are used, it will be understood that these terms are used with reference to the wiper when it is positioned with the rubber wiper blade on a horizontal plane, the terms “upper” and “lower” being in particular used with reference to the force of gravity in the usual way.

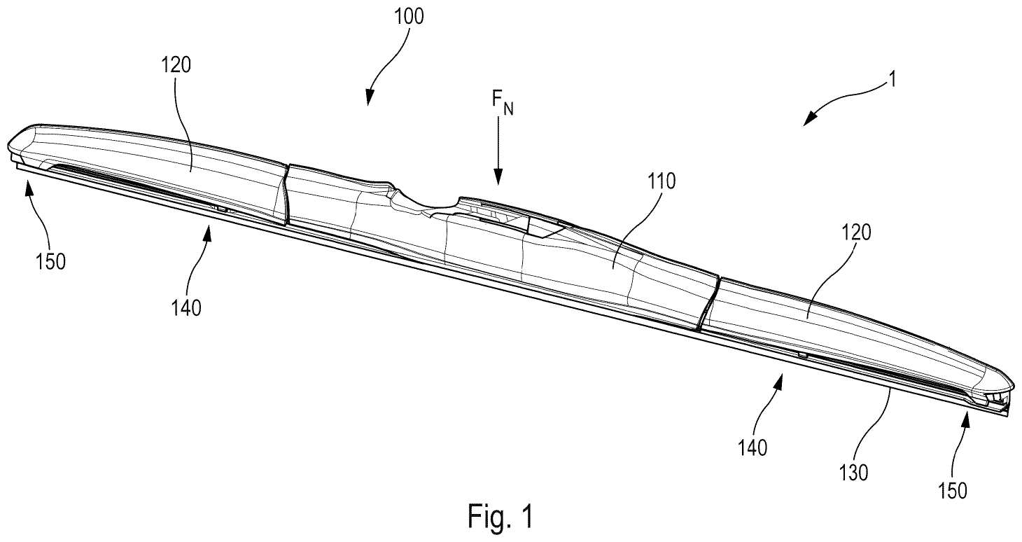

FIG. 1 illustrates a wiper 1 for a vehicle, comprising a cowling 100 according to one embodiment of the invention. The cowling 100 comprises a central mount 110 and two end caps 120. The two end caps 120 are each articulated on the central mount 110, in the longitudinal continuation thereof, by way of pivotable articulations which will be described in more detail below.

The wiper 1 also comprises a wiper blade 130, which is retained in place in the wiper 1 by yokes 140 and claws 145 and 150; a first pair of claws 145 being borne by the ends of the yokes 140 and a second pair of claws 150 being integrally formed by the end cap 120. The yokes 140 (partially visible in FIG. 1 but illustrated in more detail by the figures that follow) are arched structures comprising, at the ends thereof, claws for retaining the wiper blade 130 and pivotably articulated on the central mount 110 of the wiper 1.

These yokes 140 serve to distribute the normal force FN exerted on the wiper 1 by an arm of a wiper system of a vehicle (not illustrated) over the entire length of the wiper 1, in order to ensure wiping uniformity and closer following of the curved shape of the windshield. In conjunction with the claws 150, the yokes 140 also serve to retain the wiper blade 130 in the wiper 1.

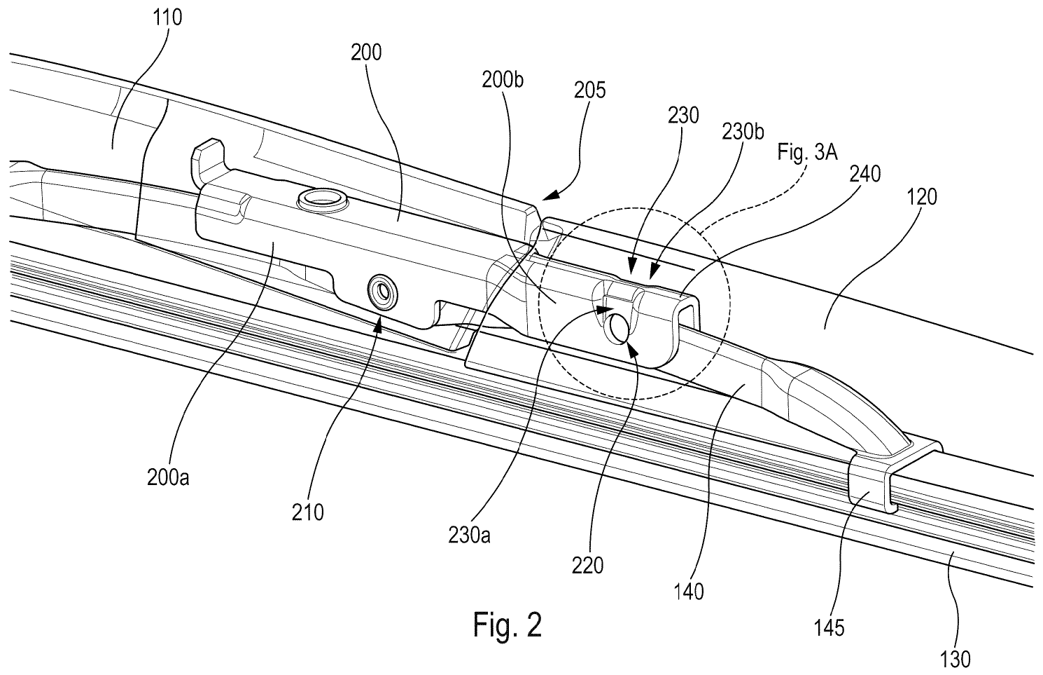

FIG. 2 illustrates the wiper 1 in FIG. 1 in more detail. In FIG. 2, the central mount 110 and one of the end caps 120 are illustrated in transparency in order to be able to better illustrate the configuration and mounting of the articulations therein.

More specifically, the articulation between the central mount 110 and the end cap 120 is effected by way of an adapter element 200. The adapter element 200 is fastened inside the central mount 110, on a first part 200a, and extends beyond a longitudinal end 205 thereof. As described above, the yoke 140 is mounted in pivotable articulation on the adapter element 200, at the articulation 210.

The adapter element 200 also comprises a second part 200b, which extends beyond the longitudinal end 205 of the central mount 110. The second part of the adapter element 200 notably has articulation bores 220 formed in its two legs, which makes it possible to mount the end cap 120 in pivotable articulation on the adapter element 200. More specifically, the end cap 120 has two articulations studs which extend from the lower surface of the end cap 120 and which are push-fitted in the articulation bore 220.

The end cap 120 is therefore effectively mounted in pivotable articulation on the central mount 110, by way of the adapter element 200.

Formed at the articulation bores 220 of the adapter element 200 is a narrowing 230 of the width of the second part 200b. In the embodiment illustrated in FIG. 2, this narrowing is constituted as a pair of inclined surfaces 230a, 230b. These inclined surfaces 230a, 230b extend from the upper edge of a corresponding articulation bore 220 to a central core 240 of the adapter element 200. In addition, in the embodiment illustrated in FIG. 2, the inclined surfaces 230a, 230b are substantially planar, apart from a transition zone at the central core 240.

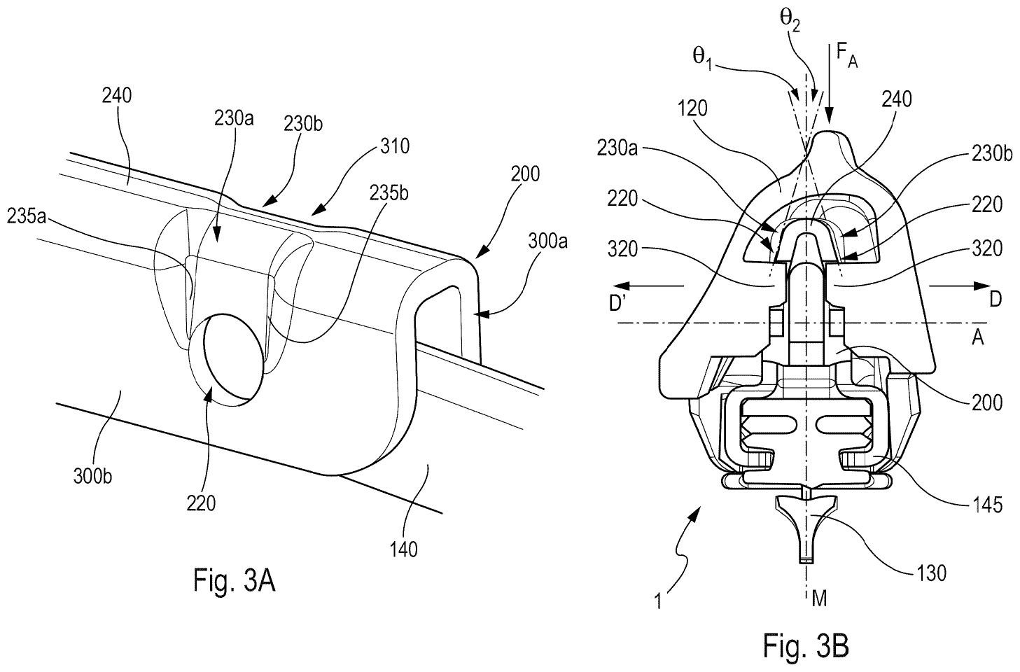

The details of the adapter element 200 will be more easily understood from the views presented in FIGS. 3A and 3B.

As illustrated in FIG. 3A, the mounting surfaces 230a, 230b are formed in legs 300a, 300b of the adapter element 200, and extend from the articulation bore 220 to the central core 240 which connects said two legs 300a, 300b. The presence of at least one mounting surface 230a, 230b constitutes a narrowing of the adapter element 200 at the articulation bore 220.

The adapter element 200 further comprises multiple guide surfaces 235a, 235b. More specifically, each of the mounting surfaces 230a, 230b are bordered on their lateral sides by two guide surfaces 235a, 235b, which each extend from the articulation bore 220 to the central core 240 of the adapter element 200. More particularly, the guide surfaces 235a, 235b are preferably substantially tangential to the articulation bore 220.

The mounting surfaces 230a, 230b are therefore delimited at the bottom by the articulation bore 220 and at the top by the central core 240 of the adapter element 200. Each mounting surface 230a, 230b is preferably, and as illustrated in FIGS. 2 and 3A, also delimited at the lateral sides by two guide surfaces (235a, 235b).

The guide surfaces 235a, 235b are substantially planar in the embodiment illustrated in this figure, but can also be concave or convex depending on the needs of the implementation in question.

The combination of a mounting surface 230a, 230b and its corresponding guide surfaces 235a, 235b all together form a channel 310. The channel 310 extends from the central core 240 of the adapter element 200 to the articulation bore 220. Advantageously, the guide surfaces 235a, 235b are inclined such that the channel 310 is wider at the central core 240 than at the articulation bore 220, thus taking the form of a funnel. This funnel form facilitates the mounting of the end cap 120 on the adapter element 200, as will be described by the figures that follow.

FIG. 3B is a cross-sectional view of the wiper 1, taken at the articulation bores 220 illustrated in FIGS. 2 and 3A. It can be seen in this figure that the end cap comprises two articulation studs 320, which each extend from the lower surface of the end cap 120, top to tail. The two articulations studs 320 therefore together form an articulation axis A.

To articulate the end cap 120 on the adapter element 200, the two articulation studs 320 are positioned on the central core 240 of the adapter element. An assembly force FA is then applied, and this forces the articulation studs 320 against the mounting surfaces 230a, 230b.

As indicated in FIG. 3B, the mounting surfaces 230a, 230b are inclined with respect to the median plane M of the wiper 1. When the assembly force FA is applied to the end cap 120, this inclination of the mounting surfaces 230a, 230b has the effect of pushing back the corresponding articulation studs 320; the two sides of the end cap 120 are thus moved apart from one another, in the directions D and D′, as illustrated in FIG. 3B.

Gradually, under the impetus of the assembly force FA, the articulation studs 320 move forward on the mounting surfaces 230a, 230b toward the articulation bores 220. At the end of their travel, the articulation studs 320 end up being push-fitted in the articulation bores 220, and the elasticity of the end cap 120 retains them in place as illustrated in FIG. 3B.

It should be noted that moving the two sides of the end cap 120 apart will produce a deformation, and therefore a mechanical stress, in the body of the end cap; the farther the end cap has to move apart, the greater this stress will be.

The provision of a narrowing in the adapter element associated with the articulation bores, such as the two mounting surfaces 230a, 230b which can be seen in FIG. 3B, is advantageous in that the initial moving apart (at the moment the assembly force FA starts to be applied and the articulation studs 320 start to move forward on the mounting surfaces 230a, 230b) will be reduced with respect to a configuration in which the adapter element does not comprise a narrowing. In addition, the presence of the mounting surfaces 230a, 230b makes it possible to better control the stresses generated in the end cap during its articulated mounting, in that the moving apart of the end cap is both less and applied more gradually.

In addition, this reduction in stresses during the articulated mounting of the end cap 120 makes it possible to make it more rigid than would be possible if the legs of the adapter element are orthogonal to the central core. Better retention of the end cap on the wiper is therefore provided, in particular under extreme use conditions such as in freezing conditions or in an automatic car wash.

It can be seen more particularly that the mounting surfaces 230a, 230b are inclined with respect to the median plane M by an angle θ1, θ2, thus forming a punctiform narrowing of the adapter element 200. It can be seen in FIG. 3B that the angles θ1, θ2 are identical, and that the mounting surfaces 230a, 230b are planar, thereby affording a substantially gradual and linear deformation of the end cap 120 until the articulation studs 320 have been properly push-fitted in the articulation bores 220 as illustrated.

As an alternative, choosing asymmetrical angles θ1, θ2 would make it possible to promote the moving apart of the cap on one of the two sides, such that the deformation in the direction D is greater than the deformation in the direction D′, or vice versa. It would also be conceivable for one of the or both mounting surfaces 230a, 230b to be curved (instead of planar, as illustrated in FIG. 3B) in order to afford a non-linear progression of deformation and stress when the end cap is being mounted on the adapter element.

According to another alternative which is not illustrated, it may be that a single mounting surface is provided on the adapter element, extending from one of the articulation bores on a single one of the legs. In such a case, the other leg of the adapter element is substantially orthogonal to the central core.

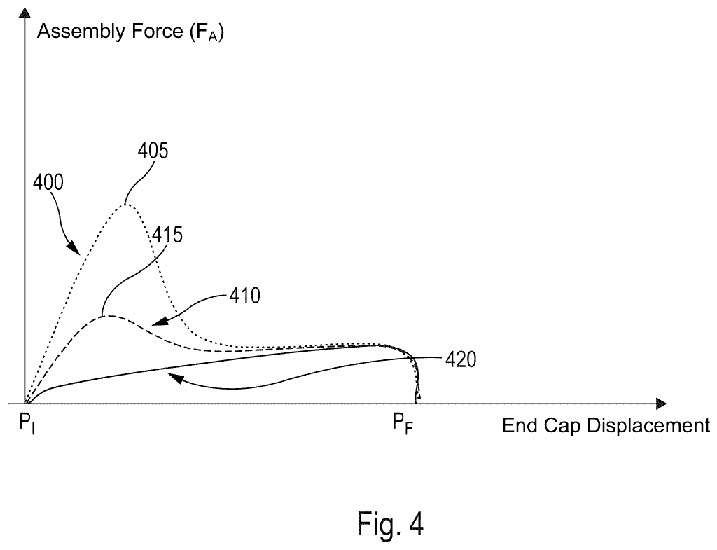

The relative reduction in the assembly force FA that is realized by the present invention is illustrated by the graph in FIG. 4. FIG. 4 shows three curves 400, 410, 420, each corresponding to the assembly force FA exerted on the end cap of a wiper during the articulated mounting thereof. The three curves 400, 410, 420 illustrate the assembly force FA against the displacement of the end cap during the articulated mounting thereof on the adapter element, from an initial position PI in which the articulation studs come into contact with the adapter element but before the cap is deformed, toward its end position PF in which the articulation studs are properly push-fitted in the corresponding articulation bores and the end cap is no longer deformed in a moved-apart state.

The first curve 400 corresponds to a configuration in which the legs of the adapter element are substantially orthogonal to the central core of the adapter element; there is therefore no narrowing in the adapter element at the articulation bores. It can be seen that this configuration requires a substantial assembly force FA at the start of the displacement of the end cap, which rapidly increases up to the peak 405 and then drops back down to a plateau. The assembly force FA remains substantially constant until the end cap arrives at its end position PF.

The second curve 410 has a configuration in which the angles θ1, θ2 are between 5 and 7 degrees, affording a slight narrowing of the adapter element at the articulation of the end cap. Consequently, even though a peak 415 in the assembly force FA is observed, it is greatly reduced with respect to the configuration of the curve 400 without any narrowing. After the peak 415, the assembly force decreases to the plateau until the end cap arrives at its end position PF.

It should be understood that the peaks 405 and 415 are the times when the assembly force is at its highest because it is at this time that the sides of the end cap have been moved farthest apart, in order to pass the articulation studs onto the adapter element. It will be recognized as a result that the narrowing of the invention is advantageous not only because it reduces the force necessary to mount the end cap in articulation, but also because it limits the deformation of said cap and therefore the mechanical stress to which it is subjected during the mounting.

In addition, this fact also makes it possible for the end cap to comprise longer articulation studs than would be possible otherwise, and this makes the articulations of the wiper 1 even more robust.

The third curve 420 has an optimized configuration, in which the angles θ1, θ2 are between 10° and 15°, and preferably are 13°. By contrast to the two preceding curves 400, 410, the third curve 420 exhibits a gentle and gradual rise in the assembly force FA up to the plateau.

The end cap therefore does not have to be dimensioned to support mounting forces which rise suddenly to a peak, but can be simply dimensioned to support the plateau. The wiper is therefore made more lightweight, without compromising its strength.

In any case, the optimal values for the angles θ1, θ2, and the mounting forces and the distance between the initial and end positions, in order to afford the assembly force curve which is optimum for the implementation in question will be easily understood by a person skilled in the art.

It will be clearly understood that the invention is not limited to the embodiments presented and other embodiments will be clearly apparent to a person skilled in the art. The disclosure above should be regarded as exemplary and non-limiting

What is claimed is:

1. A wiper, for a motor vehicle, comprising:
a cowling including a central mount and at least one end cap disposed in the continuation of the central mount;
at least one adapter element fastened to the central mount, the adapter element including a central core and two legs extending from opposite edges of the central core, one of the at least one end caps being pivotally articulated to the adapter element; wherein the adapter element has a punctiform narrowing of at least one of the two legs at the articulation of the end cap on the adapter element, the narrowing extending from at least one articulation bore to the central core of the adapter element.

2. The wiper as claimed in the preceding claim 1, wherein the narrowing includes at least one substantially planar mounting surface, the at least one mounting surface being inclined toward a median plane of the adapter element.

3. The wiper as claimed in claim 2, wherein the narrowing includes two mounting surfaces disposed oppositely with respect to the median plane of the adapter element.

4. The wiper as claimed in claim 1, wherein the at least one end cap includes two articulation studs extending top-to-tail from a lower surface of at least one end cap so as to constitute an articulation axis, the articulation studs being push-fitted in the at least one articulation bore of the adapter element.

5. The wiper as claimed in claim 1, wherein the at least narrowing is at least partially constituted by at least one mounting surface formed in the adapter element, the at least one mounting surface preferably being substantially planar.

6. The wiper as claimed in claim 5, wherein each at least one mounting surface is bordered by two guide surfaces, the at least one mounting surface and the two guide surfaces together forming a channel, the two guide surfaces being substantially planar.

7. The wiper as claimed in claim 6, wherein the channel extends from the articulation bores to the central core of the adapter element.

8. The wiper as claimed in claim 1, wherein the at least one narrowing is inclined at an angle of between 5 and 20 degrees; with respect to the longitudinal median plane of the adapter element.

9. A wiper system comprising a wiper, the wiper including a cowling including a central mount and at least one end cap disposed in the continuation of the central mount, at least one adapter element fastened to the central mount, the adapter element including a central core and two legs extending from opposite edges of the central core, one of the at least one end caps being pivotally articulated to the adapter element, wherein the adapter element has a punctiform narrowing of at least one of the two legs at the articulation of end cap on the adapter element, the narrowing extending from at least one articulation bore to the central core of the adapter element.

10. The wiper as claimed in claim 1, wherein the at least one narrowing is inclined at an angle of between 10 and 15 degrees with respect to the longitudinal median plane of the adapter element.

11. The wiper as claimed in claim 1, wherein the at least one narrowing is inclined at an angle of 13 degrees with respect to the longitudinal median plane of the adapter element.
